(19) United States
(12) Patent Application Publication
(10) Pub. No.: US 2003/0074323 A1
(43) Pub. Date: Apr. 17, 2003

(54) Business model for downloadable video games

(75) Inventor: Carolyn R. Catan, Pleasantville, NY (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/969,096

(22) Filed: Oct. 2, 2001

(51) Int. Cl. G06F 17/60

(52) U.S. Cl. 705/59

(57) ABSTRACT

A system and method for downloading video games over the Internet, for flexible time-limited play, incorporating sliding scale fees. Consumer playing interests are monitored thereby calculating a software price point and shelf life. User profiles are developed based on a combination of demographic, economic, and social information and playing preferences.

### BACKGROUND OF THE INVENTION

1. Field of the Invention

The present invention is directed to the field of software distribution. It is particularly directed toward software to be used for a limited time period.

2. Description of the Related Art

Computer software games are costly for the average consumer especially because a child's interest in a particular game may not last beyond a few plays. Accordingly, consumers necessarily limit the number of games they are willing to purchase, not only because of the absolute cost, but also because they do not perceive the games as offering value on a per-play basis. Video games are available in hotels and in video game parlors on a per-play basis and there have been some attempts to distribute video games via cable television. However, until the proliferation of access to the Internet, distribution on a per-play basis was not practical.

Methods of providing software for a limited time period are well known in the art and used by vendors to provide consumers with an opportunity to try out their software. Methods of controlling the length of time a user can use a particular software package, and methods for curtailing its use, are well known. Generally, each time the user runs the program, the user is notified of the remaining number of days or uses available and advised as to how to purchase the software. At the end of the predetermined allotted time, the software automatically becomes inoperable. Typically such trial software has been distributed on CD-ROM. However, as PCs have become more powerful and Internet connections have grown faster, software may now be distributed, in compressed form, via the Internet. The consumer downloads the software file to disk and then runs an install program, which decompresses and may also decrypt the software program. The user may connect to the Internet to purchase the software, at any time.

International Publication Number WO 9641449 entitled Try Before You Buy Software: Distribution and Marketing System describes a system and method of distributing trial software in locked form. As long as the software is locked, the user is prevented from copying or modifying the software. The system keeps a record of which programs have been sampled and the frequency of sampling. The number of times or the duration that a user can sample a particular program is limited.

European Patent Application EP 684538 Apparatus and Method for Software Access enables software to be installed on systems for an evaluation period. In recognition of the fact that some time must be spent installing the software and enabling it to run properly before evaluation can begin, a predetermined delay feature is built-in. This delay feature delays the start of the evaluation period, thereby extending the evaluation period for the amount of time the vendor estimates is required to install the software and have it operating properly.

U.S. Pat. No. 5,014,234 entitled System with Software Usage Timer and Counter for Allowing Limited Use but Preventing Continued Unauthorized Use of Protected Software, to Gordon L. Edwards, Jr., describes a method for allowed unauthorized copies of protected software to be installed and to operate for a limited time. The number of times the software is used and the elapsed time since installation are monitored. If the user does not register the software within a prescribed period of time, the software is disabled.

U.S. Pat. No. 5,944,608 entitled Computer Software Delivery System, to Reed, et al., describes an apparatus and method of broadcasting video game computer data, over cable television, to subscribers.

The prior art does not address both the consumer's interest in downloading video games over the Internet or via cable broadband, satellite and other means, for flexible time-limited play, as well as the marketer's interest in tracking the consumer's playing interests.

### OBJECT AND SUMMARY OF THE INVENTION

Accordingly, it would be desirable to offer consumers a convenient alternative to buying games outright, which would also be affordable and provide good value. As the profit margin may be lower when software is vended for a limited time period, at a lower cost for a limited number of plays, it would also be desirable to offset this lower margin by providing the vendor with marketing information regarding the consumer's interests. This information would enable the vendor to more accurately price its software, determine its shelf life, and better determine what to sell, and to whom.

The present invention addresses the foregoing needs by providing a system, (i.e., a method, an apparatus, and computer-executable process steps), for providing video games to a consumer for a limited time period. This time period may be as much as one week or more, or as little as a few hours, the usage period being consumed as the user wishes. The system includes a server, with associated storage, which communicates with a client in a network. The client downloads video games from the server for a predetermined time period.

Authorization to download is controlled by an identification scheme, which assigns a unique identifier to each item of software and a unique identifier to each client device. The identifiers are associated to form an authorization set, which will permit the user to download. Prior to download, the user registers, providing economic, social, and demographic information, as well as other information such as likes and dislikes, which is stored in a user profile and can be joined with the authorization set to track consumer software usage.

If the user deletes the downloaded software prior to expiration of the predetermined allowed usage time, this information is recorded by a monitoring portion. An incentive is provided for deletion before expiration. When the predetermined time period expires, the user is allowed to extend the time period for free, for a predetermined term. Subsequently, the user may extend the time period again for a reduced fee. A history of extensions is maintained so that the true value of the software to the user can be determined from the number of extensions. A price per use is developed based on the price, the shelf life, and the duration of a typical one-time use.

Time of usage is used to calculate a shelf life for the software. Fee information is used to calculate a price point for the software.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

FIG. 1 depicts a system on which the present invention may be implemented.

FIG. 2 is a diagram of the server processor.

FIG. 3 is a flow diagram used for explaining the operation of the present invention.

FIG. 3a is a flow diagram used for explaining, in more detail, a sub-process of the main flow diagram.

### DETAILED DESCRIPTION OF THE PREFERRED EMBODIMENTS

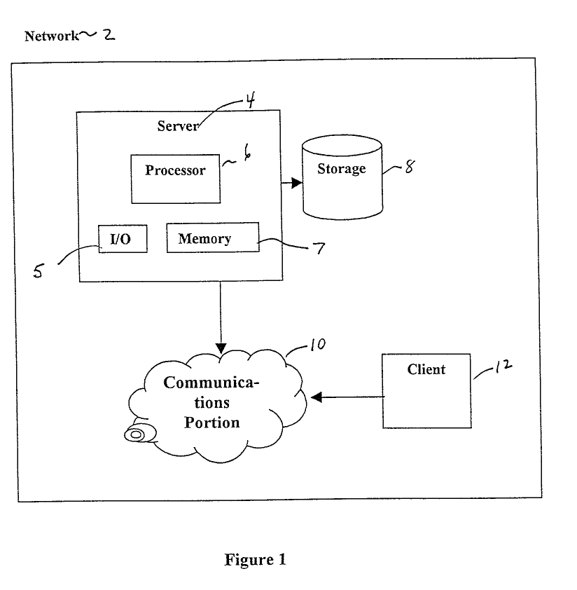

FIG. 1 shows a system in which the present invention can be implemented. The server 4 is a computer containing a processor 6, input/output 5,and memory 7, which is associated with storage 8. The server 4 communicates with a client device 12 through a communications portion 10. The client device is a PC, personal digital assistant, cell phone, television set including a processor, set-top box, or dedicated video game console, for example. The client and server communicate via a wiring system, cable, satellite, or through wireless communication.

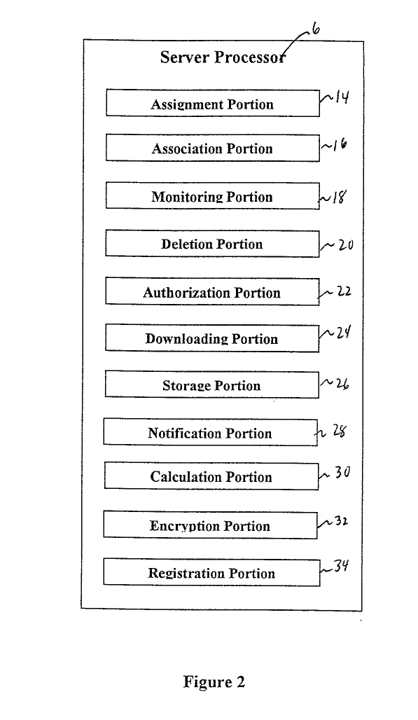

FIG. 2 shows the elements of the server processor 6. The assignment portion assigns a unique identifier to each software program available for download and each client device. The identifier for the client device is for example a television serial number, set-top box number, or some variation of the number. The association portion associates the unique identifiers so there is a record of those programs each client device is authorized to download via the downloading portion 24. The association must be verified by the authorization portion 22 before a download is permitted.

The association is stored via the storage portion 26. As shown in FIG. 1, storage may be in the secondary storage 8 or in memory 7. Secondary storage may be a diskette, CD-ROM, zip disk, memory stick or other type of non-transitory memory. The software to be downloaded is encrypted prior to download, via the encryption portion 32 and decrypted by the client.

Returning to FIG. 2, the monitoring portion 18 monitors the client's usage and notifies the client, via the notification portion 28, when the predetermined time period has expired. If the client decides not to extend the time period, the software package is deleted from the client via the deletion portion 20. This can be done in numerous ways well known in the art.

For example, when the client connects to the network 2, as shown in FIG. 1, a process on the server may activate a process on the client and delete the software. In an alternate embodiment, a monitoring portion on the client, monitors when the predetermined time period has elapsed and activates a deletion process which runs in the background on the client. In still another way, the software program itself may contain a counter program, which measures the number of times the software has been loaded, and deletes the software after a predetermined number of loads.

If the client decides to extend the predetermined period, the client can do so for free for one additional week, for example. After the first free extension, the client can extend the predetermined period for a reduced fee. There is no limit on the number of such extensions. The extension terms are variable from package to package, from user to user, and from time period to time period.

The monitoring portion 18, working in conjunction with the storage portion 26, tracks all usage time and fees charged to a particular client, related to a particular software package. This information is stored via the storage portion 26 so a complete record of usage is associated with a particular software package and a particular user, by joining the tables below.

The tables contain the following information:

Authorization Table

| Association ID | Software ID | User ID |
|---|---|---|
| 00002 | 00001 | 00005 |

Usage Table

| Association ID | Start Time | End Time | Fee |
|---|---|---|---|
| 00002 | Aug. 18, 2000 | Aug. 26, 2000 | $5.00 |
| | 2:12:31 PM | 2:12:31 PM | |
| 00001 | Aug. 26, 2000 | Sep. 3, 2000 | $0.00 |
| | 2:12:31 PM | 2:12:31 PM | |
| 00001 | Sep. 3, 2000 | Sep. 10, 2000 | $2.50 |
| | 2:12:31 PM | 2:12:31 PM | |

Software Table

| Software | | | | |
|---|---|---|---|---|
| ID | Title | Size | Initial Fee | Category |
| 00001 | Beat the Bad Guys | 5 megabytes | $5.00 | Action |

These tables are merely illustrative of one way of storing this information. Numerous variations are possible. These tables are joined with personal profile information, which is input to the registration portion by the client. An example of a personal profile table is shown below:

Personal Profile Table

| | | | | | Zip | Family |
|---|---|---|---|---|---|---|
| User ID | Age | Income | Gender | Race | Code | Members |
| 00005 | <10 | <$50,000 | Male | White | 10001 | Mother, |
| | | | | | | Sister |

The personal profile table can be joined with the authorization table and usage table to provide information to marketers on the target audience for a particular piece of software.

The calculation portion 30 uses the information stored in the tables to calculate the shelf life of each software package. The shelf life is the duration of time a user wants to play a particular software package. Shelf life is calculated on a user by user basis and then aggregated. For the example given in the Usage Table above, shelf life would be calculated by subtracting the start time from the end time, giving a usage time, and summing the usage times, giving a shelf life of 24 days. A shelf life reflecting all users can be aggregated by averaging individual user shelf lives or using other well-known statistical methods.

The calculation portion 30 also calculates a price point for each software package, the price point being the dollar amount a user would be willing to pay to purchase a particular software package. In the example tables given above, the price point would be calculated by summing the fee column, giving a total of $7.50.

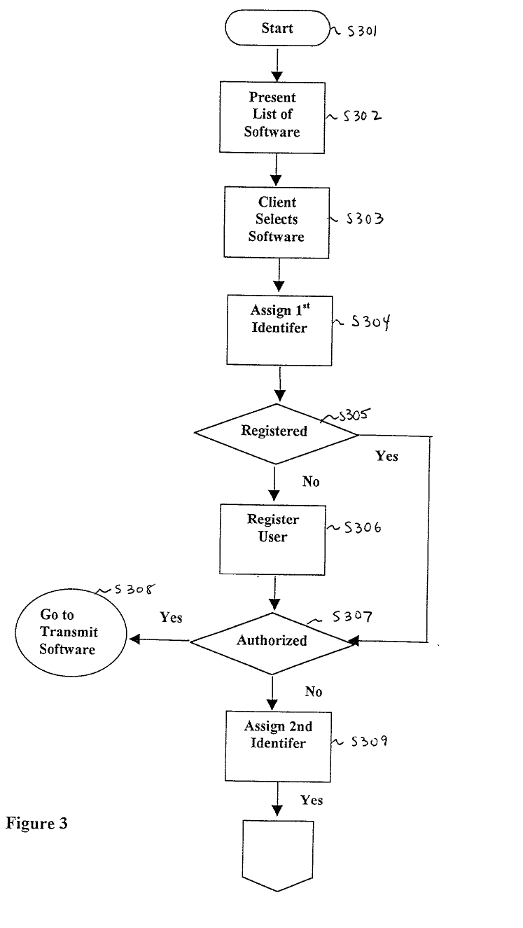

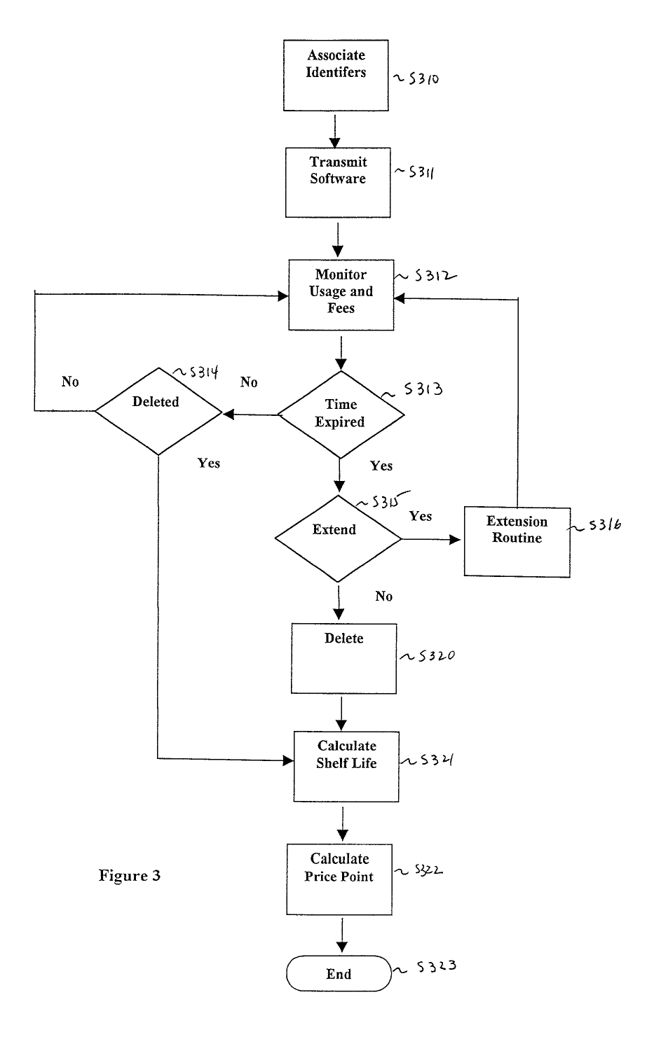

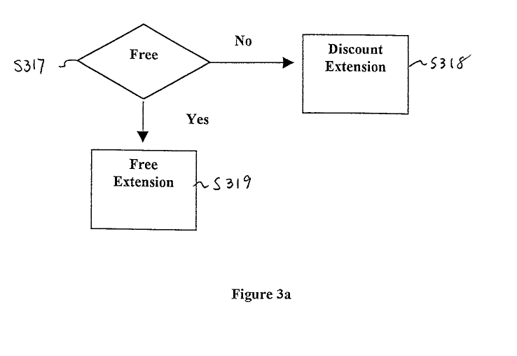

FIG. 3 is a flow chart explaining the operation of the invention. After the user accesses the system in step S301, a list of software available for download is presented to the user in step S302. This may be in the form of a web page displayed on the client device, an email message, or a display on the user's cell phone, for example. The user selects an item to download in step S303 using an input device such as a mouse, television remote control, or touch screen, for example. In step S304, a unique identifier is assigned to the program to be downloaded. This identifier is stored in memory so it can be accessed and applied each time the particular software package is downloaded, by any user.

In step S305, the stored personal profiles are checked to determine whether the user has already registered to download software. If the user is not on file, the user is asked to register. During the registration process step S306, the user answers questions, which reveal economic, social, and demographic information. These may include questions such as “What is your zip code?” or “Are you a student?” This personal profile information is stored and associated with a unique identifier, which identifies the user.

Next in step S307, the association file is checked to determine whether the user is authorized to download the particular software package he has requested. If the user has already been authorized, the user proceeds in step S308 to step S311, to transmit the software. Generally the user must submit an initial fee for the first download. If for some reason the software is deleted or becomes inoperable, the user can re-download as long as the user is authorized.

If the user is not authorized, a unique identifier for the software package is assigned, or retrieved from memory and assigned, and the pair of unique identifiers, one for the user and one for the software package are associated in step S310 and stored. In step S311 the software is transmitted from the server to the client via the communications portion.

After download, in step S312, the monitoring portion tracks any fees paid by the user and the amount of time the user is using the software. Fees paid and the duration of any periods of use are captured and stored in the Usage Table, pictured above. There may be multiple periods of use. Tracking is accomplished in numerous ways well known in the art. The beginning and end of each time period of use is date-stamped, for example, as the operating system provides a clock. Fees paid may be captured via a form on a web page which asks the user to select a time period and fee, for example. Alternatively, the fee is calculated, and then the user is prompted for acceptance of the fee, via an e-mail message, for example.

Periodically, the monitoring portion will verify, in step S313, that the time period of use allotted to the user has not expired. For example, each time a user logs into the system, or at a preset time of day, the usage table is accessed to determine which users have expended their allotted time. Users whose time has expired are flagged for notification.

The monitoring portion in step S314 also checks to see whether a user has deleted the downloaded software before the expiration of the allotted usage period. This is important as it enables marketing personnel to more accurately calculate the shelf life of a software product. An incentive for early deletion is provided. For example, a portion of the fee is returned or the user receives a reduction in the purchase price of another product offered by the vendor, or an affiliate of the vendor. Monitoring is accomplished, for example, through a program, which is installed on the client, at the time of download, which monitors deletion of the file containing the software program. When the user issues a delete command, the monitor program asks the user if the user really wants to delete the software. If the user does, the server is notified. Notification can be accomplished in many ways, for example via an email message to the server, which is sent via a background process.

When the monitor determines that a user's allotted usage period has expired, in step S313, the user is notified. In step S315, the user is asked whether the user wants to extend the time period. Notification is via email or other method, a message the next time the user logs into the system, or through other well-known methods. If the user wants to extend the user's time of use, an extension routine in step S316, shown in FIG. 3a is activated.

Referring now to FIG. 3a, in step S317, the monitor determines whether or not the user is entitled to a free extension period. This is derived from the usage table, by checking for a zero dollar amount in the fee column, or using an ancillary calculation routine, for example. If there have been no time extensions, the user is given a free one-week extension in step S319 which is then entered into the usage table. Calculating whether or not the allotted time period has expired is now based upon the renewal date, not the initial date of download. If there has already been a free extension, in step S318, the user is given an extension, for a fee less than the original fee charged at download. In either case, when there is a renewal, a new expiration date for the allotted time period is sent to the client.

Returning to FIG. 3, in step S320, the software is automatically deleted if the user has not requested an extension. By default, the deletion program is set to run at a preset time of expiration. However, when there is a renewal, the preset time of expiration is reset to an advanced date. The deletion program is automatically run from the client at the expiration time. However, in alternate embodiments it can also be run from the server. Each time the user activates a game, login to the server is activated as a background process and deletion initiated therefrom.

Once an item of software has been deleted, in step S321, the shelf life of the software is calculated. The shelf life is the sum of all the periods of usage, which can be ascertained from the Usage Table pictured above. In step S322, the price point is calculated as the sum of the fees paid in the Usage Table. A variety of methods of calculating the price point are possible and may take into account the demographics of the user. Price point and shelf life can be aggregated across the total number of users giving a mean price point and shelf life. Analysis of the information in the Usage and Personal Profile Tables, pictured above, provides marketing information at the local level, based on zip code, as well as demographics.

The present invention has been described with respect to particular illustrative embodiments. It is to be understood that the invention is not limited to the above-described embodiments and modifications thereto, and that various changes and modifications may be made by those of ordinary skill in the art without departing from the spirit and scope of the appended claims.

What is claimed is:

1. A client device in communication with a server, which selects and pays for at least one item of a full version of computer software, to be used for a predetermined period which can be shortened by the client, the software being selected from a list of software downloadable from the server, following authorization by the server, the software being automatically disabled at termination of the predetermined period, unless the client requests an extension of the predetermined period, the actual active usage of the software by the client thereby being monitored by the server and stored.

2. The client device as claimed in claim 1, wherein the client device is authorized by the server via:
1) an assignment portion for assigning a first unique identifier to the at least one item of software and a second unique identifier to the client device;
2) an association portion for associating the second unique identifier with the first unique identifier and storing the association such that there is a record of each item of software that the client device is authorized to download; and
3) a comparator portion for comparing the stored second unique identifier with an identifier transmitted by the client device to determine whether the client device is authorized to download the selected at least one item of computer software.

3. The client device as claimed in claim 1, wherein usage is monitored by a monitoring portion which monitors the amount of time elapsed from when the client device has downloaded the at least one item of software and any fees paid for using the at least one item of software.

4. The client device as claimed in claim 1, wherein the software is disabled by a server cancellation portion, which deletes the at least one item of software from the client device when the predetermined time period has elapsed.

5. The client device as claimed in claim 2, wherein a server cancellation portion disassociates the first unique identifier, identifying the at least one item of software from the second unique identifier, identifying the client, unless the client device requests an extension of the predetermined time period via a communications portion.

6. The client device as claimed in claim 2, wherein the client device receives from a server downloading portion the selected at least one item of software when the server authorization portion finds a match between the stored second unique identifier and the identifier transmitted by the client device.

7. The client device as claimed in claim 1, wherein the client device is notified by a server notification portion, via a communications portion, when the predetermined time period has elapsed.

8. The client device as claimed in claim 1, wherein the client device can delete the received item of software, before the predetermined time period has elapsed, and a notice of the deletion is transmitted to a server monitoring portion via a communication means and stored in a server storage portion.

9. The client device as claimed in claim 1, wherein the client device may request an extension of the predetermined time period from the server, at no cost, and notice of the extension of the predetermined time period is monitored by a server monitoring portion and stored in a server storage portion

10. The client device as claimed in claim 1, wherein the client device may request permission from the server to use the at least one item of software for a second predetermined time period, paying a fee for using the at least one item of software which is less than a fee paid for the first predetermined time period, and transmitting notice of using the at least one item of software for the second predetermined time period to a server monitoring portion, the notice being stored by a server storage portion.

11. The client device as claimed in claim 1, wherein the client device is a personal computer.

12. The client device as claimed in claim 1, wherein the client device is a dedicated game console.

13. The client device as claimed in claim 1, wherein the time period during which the client device has used the at least one item of software is calculated by a server calculation portion, based upon data monitored by a server monitoring portion and stored in a server storage portion.

14. The client device as claimed in claim 13, wherein the server calculation portion calculates the price point for the at least one item of software, based upon any fees paid, the fees paid having been monitored by the server monitoring portion and stored by the server storage portion.

15. The client device as claimed in claim 13, wherein the server calculation portion calculates the shelf life of the at least one item of software, based upon the time period during which the client device has used the at least one item of software, the time period having been monitored by the server monitoring portion and stored by the server storage portion.

16. The client device as claimed in claim 1, wherein the at least one item of software received is encrypted by an encryption portion of a server processor, and decrypted by the client device.

17. The client device as claimed in claim 1, wherein the client device transmits personal profile information to the server for storage in a server storage portion such that information tracked by a server monitoring portion is associated with the personal profile information.

18. A method of receiving computer software from a server, for use for a predetermined time period by a client, comprising the steps of:
(a) transmitting client identification information to the server so that the server can authorize a download of at least one item of computer software by the client;
(b) selecting at least one item of software to be received;
(c) downloading the selected item of software, its usage being monitored and stored by the server such that expiration of the predetermined time period can be ascertained;
(d) requesting additional usage from the server, before the predetermined time period elapses, to avoid automatic invalidation of the selected item of software.

19. The method as claimed in claim 18, further including an authorization step wherein the server authorizes the download by:
a) assigning a first unique identifier to each item of software to be distributed;
b) assigning a second unique identifier to the client authorized to receive software;
c) associating the first unique identifier with the second unique identifier such that there is a stored record of each item of software that the client is authorized to receive;
d) determining whether the identification information transmitted by the client, and the second unique identifier are associated, prior to transmitting the selected item of software to the client.

20. The method as claimed in claim 18, further including a notification step wherein the client receives notification from the server when the predetermined time period has expired.

21. The method as claimed in claim 18, further including a fee monitoring step wherein the server monitors any fees paid by the client for using the selected item of software.

22. The method as claimed in claim 18, further including a deletion notification step wherein the client notifies the server when the client deletes the received selected item of software before the predetermined time period has elapsed, and the server calculates and stores a length of time that the client used the received selected item of software.

23. The method as claimed in claim 18, wherein the client can extend the predetermined time period at no cost and notice of the extension of the predetermined time period is transmitted to the server and stored therein.

24. The method as claimed in claim 18, wherein the client can use the selected item of software for a second predetermined time period, paying a fee for using the selected item of software which is less than the fee paid for the first predetermined time period, and notice of using the selected item of software for the second predetermined time period is transmitted to the server and stored.

25. The method as claimed in claim 18, further including a decryption step wherein the client decrypts the received selected item of software.

26. The method as claimed in claim 18, further including a shelf life calculation step wherein the server calculates a shelf life of the selected item of software as a sum of the predetermined time period plus any extensions to the predetermined time period, unless the software received by the client is deleted before the predetermined time period elapses, in which case the shelf life is measured as a time period between receipt and deletion of the selected item of software.

27. The method as claimed in claim 18, further including a price point calculation step wherein the server calculates a price point for the selected item of software, based upon any fees charged, unless the received selected item of software is deleted before the predetermined time period elapses.

28. The method as claimed in claim 18, further including a user profile step wherein the server creates a user profile by eliciting demographic, social, and economic characteristics from the client, when the client registers to use the system, such that the user profile can be associated with information monitored by a server monitoring portion.

29. The method as claimed in claim 18, further including a repeating customer identification step wherein the server identifies repeat customers by referencing monitoring information which includes the number of different games the user has downloaded.

30. The method as in claim 18 wherein the predetermined time period is of a duration measured by one play.

31. Computer-executable process steps, the computer-executable process steps being stored on a computer-readable medium, enabling a client device in a network, to download at least one item of computer software, which can be used only for a predetermined time period, comprising:
an authorization step to authorize the download;
a selecting step which enables the client to select the at least one item of computer software from an inventory of available items of downloadable software for download and execution;
a downloading step to download the authorized, selected at least one item of computer software;
a monitoring step to monitor the amount of time elapsed from when the client device downloads the at least one item of software and any fees paid for using the at least one item of software;
a deletion step to automatically delete the at least one item of software from the client, when the predetermined time period has elapsed.

32. In a network, a system enabling a client device in a network, to download at least one item of computer software, which can be used only for a predetermined time period, comprising:
authorization means for authorizing the download;
means for selecting the at least one item of computer software, from a list of downloadable software, and receiving and executing at least some portion of the at least one item of computer software;
downloading means for downloading the selected at least one item of software;
monitoring means for monitoring the amount of time elapsed from when the client downloads the at least one item of software and any fees paid for using the at least one item of software;
disabling means for automatically disabling the at least one item of software, when the predetermined time period has elapsed, unless the client requests an extension of the predetermined time;
storage means for storing the at least one item of computer software, and authorization information.

33. A method of determining a true value of a software program by
downloading the software program for a price and a usage period; and
monitoring at least one of the following:
a) deletion before the usage period expires
b) a number of extensions of the usage period a client orders
in conjunction with calculating and recording a price per usage period in order to determine the true value of the software program.

34. The client device as claimed in claim 1, wherein the computer software comprises video game software.

35. A method of receiving computer video game software from a server, for use for a predetermined time period by a client, comprising the steps of:
(a) transmitting client identification information to the server so that the server can authorize a download of at least one item of video game software by the client;
(b) selecting at least one item of video game software to be received;
(c) downloading the selected item of video game software, its usage being monitored and stored by the server such that expiration of the predetermined time period can be ascertained;
(d) requesting additional usage from the server, before the predetermined time period elapses, to avoid automatic invalidation of the selected item of video game software.

36. The method as claimed in claim 35, wherein the predetermined time period is of a duration measured by one play.
